(19) United States
(12) Patent Application Publication
(10) Pub. No.: US 2015/0253926 A1
(43) Pub. Date: Sep. 10, 2015

(54) SEMICONDUCTOR DEVICE AND ELECTRONIC APPARATUS

(71) Applicant: Synaptics Display Devices KK, Tokyo (JP)

(72) Inventors: Shigeru OTA, Kodaira (JP); Takashi UEHARA, Kodaira (JP); Kota KITAMURA, Kodaira (JP); Takahiro SUZUKI, Kodaira (JP)

(21) Appl. No.: 14/628,674

(22) Filed: Feb. 23, 2015

(30) Foreign Application Priority Data
Mar. 5, 2014 (JP) 2014042449

(51) Int. Cl. G06F 3/041; G06F 3/044

(52) U.S. Cl. CPC G06F 3/0418; G06F 3/0412; G06F 3/044

(57) ABSTRACT

A semiconductor device has a touch panel controller. The touch panel controller has electrodes which are used for periodically capturing signals arising on electrodes of a touch panel having the electrodes extending X and Y directions and arranged at predetermined intervals, and which are divided into groups in units of more than one electrode; and a detection circuit for each group. The touch panel controller performs a touch detection scan and a noise detection scan; in the touch detection scan, each detection circuit accepts input of signals from the electrodes sequentially selected according to a time-division method to produce detection data in the corresponding group; and in the noise detection scan, each detection circuit accepts input of signals from the electrodes all selected in the corresponding group to produce detection data.

### CROSS-REFERENCE TO RELATED APPLICATIONS

The Present application claims priority from Japanese application JP 2014-042449 filed on Mar. 5, 2014, the content of which is hereby incorporated by reference into this application.

### BACKGROUND

The present invention relates to a semiconductor device having a touch panel controller, and a technique useful in application to touch detection control of e.g. a mutual capacitance type touch panel.

In touch detection according to a mutual capacitance method, one of an array of X-electrodes and an array of Y-electrodes, which are arranged to intersect with each other, is used as an array of drive electrodes, and the other is used as an array of detection electrodes; while the drive electrodes are selected and driven sequentially, detection data are taken at intersection positions where each drive electrode selected and driven intersects with the detection electrodes. In touch detection according to a self capacitance method, detection data according to a touch or no touch are acquired by performing charge transfer on each electrode of X-electrodes and Y-electrodes, which are arranged to intersect with each other. Either of the detection methods needs a detection circuit for touch detection which performs detection by capturing signals arising on detection electrodes in units of the detection electrodes. An integration circuit, a switched capacitor circuit or the like is used for such detection circuits. Japanese Unexamined Patent Application Publication No. JP-A-2012-234475 discloses an embodiment in which an integration circuit with operational amplifiers is used for such a detection circuit according to a mutual capacitance method. Further, the amount of signals detected by such a detection circuit is very small, so a power source noise, drive noise from a display driver and the like can cause the touch detection accuracy to worsen. To suppress the noise influence like this, a noise detection circuit may be provided additionally as disclosed in e.g. JP-A-2011-180401, whereby a technique for making determination about a touch or no touch by calculating the difference between an output of a detection circuit for touch detection and an output of a noise detection circuit can be applied.

Examples of the documents concerning the related art relate to the invention hereof include: JP-A-2012-234475; and JP-A-2011-180401.

### SUMMARY

One embodiment of the present disclosure includes a semiconductor device. The semiconductor devices includes a touch panel controller operable to periodically capture signals using receiver electrodes disposed in a touch panel to generate detection data indicating a touch or no touch. Further, the receiver electrodes are part of touch panel electrodes that extend in X and Y directions and are arrayed at predetermined intervals in the X and Y directions. The touch panel controller includes detection circuits where the receiver electrodes are divided into groups of at least two of the receiver electrodes and each of the detection circuits corresponds to a respective one of the groups. The touch panel controller is operable to perform a touch detection scan and a noise detection scan. During the touch detection scan, each detection circuit accepts input of signals from the receiver electrodes sequentially selected in a time-division manner to produce detection data for the respective group. During the noise detection scan, each detection circuit accepts input of signals from the receiver electrodes simultaneously in the corresponding group to produce detection data.

Another embodiment of the disclosure is an electronic apparatus that includes a touch panel, a touch panel controller, a liquid crystal display panel, and a display driver configured to control the liquid crystal display panel disposed under the touch panel. The touch panel controller is operable to periodically capture signals using receiver electrodes disposed in the touch panel to generate detection data indicating a touch or no touch. Further, the receiver electrodes are part of touch panel electrodes that extend in X and Y directions and are arrayed at predetermined intervals in the X and Y directions. The touch panel controller includes detection circuits where the receiver electrodes are divided into groups of at least two of the receiver electrodes and each of the detection circuits corresponds to a respective one of the groups. The touch panel controller is operable to perform a touch detection scan and a noise detection scan. During the touch detection scan, each detection circuit accepts input of signals from the receiver electrodes sequentially selected in a time-division manner to produce detection data for the respective group. During the noise detection scan, each detection circuit accepts input of signals from the receiver electrodes simultaneously in the corresponding group to produce detection data.

### BRIEF DESCRIPTION OF THE DRAWINGS

FIG. 1 is a block diagram showing, by example, the details of an input switch part and a detection part in a touch panel controller 2;

FIG. 2 is a block diagram showing, by example, the outline of a personal digital assistant including a panel module for liquid crystal display and touch detection;

FIG. 3 is a timing chart showing, by example, states of X-electrodes selected by the switches SW1_1 to SWM_n in touch detection scan; and

FIG. 4 is a timing chart showing, by example, states of the X-electrodes selected by the switches SW1_1 to SWM_n in noise detection scan.

### DETAILED DESCRIPTION

### 1. Introduction

Providing a detection circuit (formed by an integration circuit, a switched capacitor circuit or the like) exclusively for each electrode for detection leads to an increase in the number of detection circuits, which increases the chip area of a touch panel controller. More detection circuits may be needed as the detection surface of a touch panel increases. Embodiments herein include dividing electrodes for detection into groups in units of more than one electrode; disposing a detection circuit for each group; selecting electrodes in each group according to a time-division method; and connecting the electrode thus selected to the corresponding detection circuit.

Further, as to noise detection, means for diverting detection circuits to noise detection without providing additional noise detection circuits are discussed. Especially, in case that a scan for noise detection is the same as a scan for touch detection, scan time is expected to be longer in either scan.

One advantage of the embodiments described herein is to downsize a semiconductor device with a touch panel controller provided on the chip. Further, another advantage of the embodiments described herein is to make a scan time for noise detection shorter than a length of time required for touch scan for one touch frame.

The above and other problems and novel features will become apparent from the description hereof and the accompanying diagrams.

In one embodiment, the semiconductor device has a touch panel controller. The touch panel controller has electrodes which are used for periodically capturing signals arising on electrodes of a touch panel having the electrodes extending X and Y directions and arranged at predetermined intervals, and which are divided into groups in units of more than one electrode; and a detection circuit for each group. The touch panel controller performs a touch detection scan and a noise detection scan; in the touch detection scan, each detection circuit accepts input of signals from the electrodes sequentially selected according to a time-division method to produce detection data in the corresponding group; and in the noise detection scan, each detection circuit accepts input of signals from the electrodes all selected in the corresponding group to produce detection data.

The effect achieved by the representative embodiment of the embodiments disclosed in this application will be described briefly in below.

The electrodes for detection are divided into groups in units of more than one electrode; and detection circuits are disposed for the groups respectively. The detection circuits are diverted to noise detection. From these viewpoints, the downsizing of a semiconductor device with a touch panel controller provided on the chip can be achieved. Further, in the noise detection scan, the electrodes for detection are all selected, and a total quantity of noise is detected for each group. Therefore, unlike a method which enables the detection of noise in units of electrodes, a length of time required for noise detection can be shortened with the same scan method as in the touch detection scan.

### 2. Summary of the Embodiments

First, summary of representative embodiments of the invention disclosed in the application will be described. Reference numerals in diagrams in parentheses referred to in description of the summary of the representative embodiments just denote components included in the concept of the components to which the reference numerals are designated.

[1] Electrodes for detection are selected according to a time-division method in touch detection scan, whereas the electrodes for detection are all selected in noise detection scan

The semiconductor device (1) includes: a touch panel controller (2) operable to periodically capture signals arising on electrodes of a touch panel (4) to produce detection data according to a touch or no touch, where the touch panel electrodes extend in X and Y directions, and are arrayed at predetermined intervals in these directions. The touch panel controller has detection circuits (12_1 to 12_{—}m); electrodes (RX1_1 to RXm_n) used for capturing the signals are divided into groups in units of more than one of the electrodes; and the detection circuits correspond to the groups respectively. The touch panel controller performs a touch detection scan and a noise detection scan; in the touch detection scan, each detection circuit accepts input of signals from the electrodes sequentially selected according to a time-division method to produce detection data in the corresponding group; and in the noise detection scan, each detection circuit accepts input of signals from the electrodes all selected in the corresponding group to produce detection data.

According to the embodiment like this, the electrodes for detection are divided into groups in units of more than one electrode; and detection circuits are disposed for the groups respectively. The detection circuits are used to perform the noise detection scan. From these viewpoints, the downsizing of a semiconductor device with a touch panel controller provided on the chip can be materialized. Further, in the noise detection scan, the electrodes for detection are all selected, and a total quantity of noise is detected for each group. Therefore, unlike a method which enables the detection of noise in units of electrodes, a length of time required for noise detection can be shortened with the same scan method as in the touch detection scan. It is obvious that the method for touch detection by the touch panel controller may be any of a mutual capacitance method and a self capacitance method.

[2] Time-Division Switches for Electrodes Sharing Each Detection Circuit

The semiconductor device as described in [1] further includes switches (SW1_1 to SWm_n) between inputs of the detection circuits and the corresponding electrodes; the detection electrodes are selected by the switches according to a time-division method in each group in the touch detection scan; and all the detection electrodes are selected by the switches in each group in the noise detection scan.

According to the embodiment like this, it becomes possible to easily select the detection electrodes in each group.

[3] Touch Detection Scan and Noise Detection Scan in a Frame Rate Period

The semiconductor device as described in [2] further includes a control part (10) operable to control execution of the touch detection scan and the noise detection scan in a display frame rate period.

The embodiment like this allows the determination about a touch or no touch by the touch detection scan to reflect the result of detection by the noise detection scan in each display frame rate period, and it can contribute to the improvement of the determination system of touch coordinates.

[4] Case of Mutual Capacitance Type

In the semiconductor device as described in [1], the electrodes are composed of: X-electrodes (RX1_1 to RXm_n) extending in an X direction and arrayed at predetermined intervals in a Y direction; and Y-electrodes (TY1 to TYi) extending in the Y direction and arrayed at predetermined intervals in the X direction. The detection circuits are provided for groups respectively; and the X-electrodes are divided into the groups in units of more than one of the X-electrodes. In the touch detection scan, each detection circuit captures signals according to capacitance components formed between each Y-electrode driven during the time when the Y-electrodes are sequentially driven, and the X-electrodes selected in units of the groups according to the time-division method, and produces detection data for each intersection of the X- and Y-electrodes. In the noise detection scan, the detection circuits capture signals according to capacitance components formed between the X-electrodes all selected in each group and the Y-electrodes with the Y-electrodes not being driven sequentially, and create detection data for each X-electrode.

According to the embodiment like this, the effect of reducing the number of detection circuits can be achieved on the side of the X-electrodes where the detection circuits are disposed in the case of performing a touch detection according to a mutual capacitance method which allows a multi-touch detection to be handled. Incidentally, in the case of performing the touch detection according to the self capacitance method, the effect of reducing the number of detection circuits can be achieved on both the sides of the X- and Y-electrodes where the detection circuits are disposed.

[5] All of Y-Electrodes are Stopped from being Driven in Noise Detection Scan

In the semiconductor device as described in [4], the Y-electrodes are stopped from being driven during the noise detection scan.

According to the embodiment like this, only noise components can be accumulated and detected by the detection circuits.

[6] Processor that Makes Determination about a Touch or No Touch, and Determination about a Noise Level

The semiconductor device as described in [1] further includes a processor which determines a touch or no touch based on detection data detected in the touch detection scan, and determines a noise level based on detection data detected in the noise detection scan.

The embodiment like this can contribute to the downsizing of a system, the shortening of time until a result of the determination about a touch or no touch is obtained in comparison to a case in which such a processor is arranged in another chip.

[7] Built-in Display Driver

The semiconductor device as described in [1] further includes a display driver (3) which performs display control of a liquid crystal panel (5) disposed under the touch panel (4).

The embodiment like this can contribute to the downsizing of a system and the facilitation of touch detection in synchronization with a display timing in comparison to a case in which a liquid crystal driver is arranged in another chip.

[8] Electronic Apparatus Having the Semiconductor Device, a Touch Panel and a Liquid Crystal Display Panel

The electronic apparatus (30) has: the semiconductor device as described in [7]; a touch panel; and a liquid crystal display panel. The semiconductor device performs display control of the liquid crystal display panel, and control of touch detection by the touch panel.

The embodiment like this can contribute to the downsizing of a frame like a picture frame for a peripheral portion of a display screen in an electronic apparatus, such as a panel module having a touch detection function and a display function incorporated therein.

### 3. Further Detailed Description of the Embodiments

The embodiments will be described further in detail.

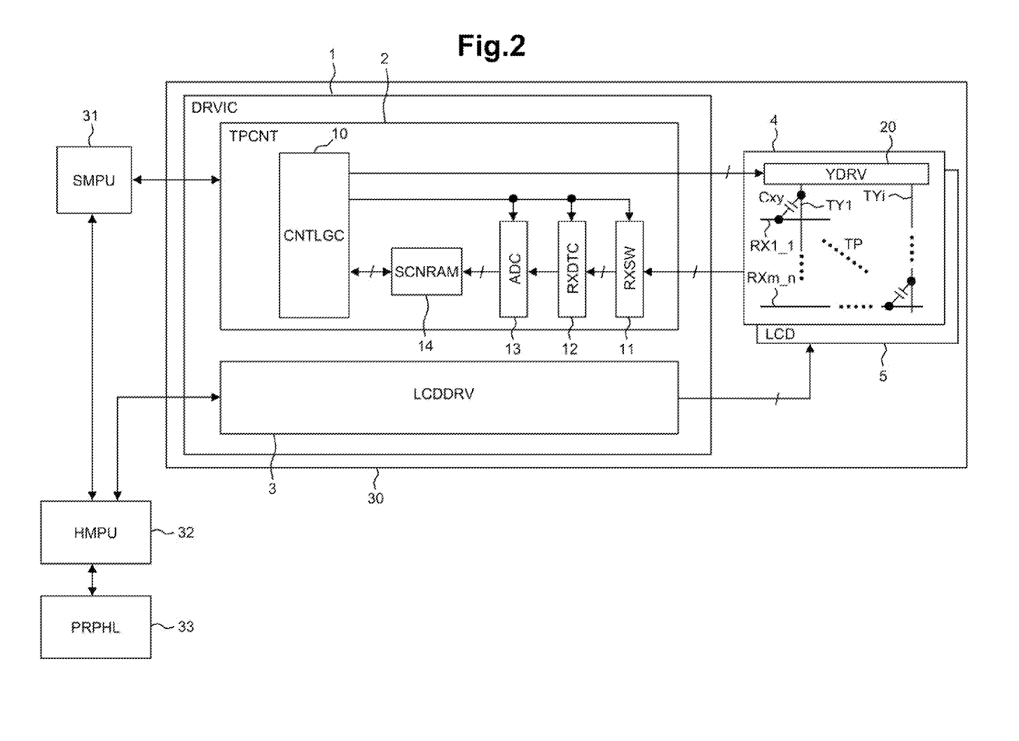

FIG. 2 shows, by example, the outline of a PDA (Personal Digital Assistant) having a panel module for liquid crystal display and touch detection.

Although no special restriction is intended, the personal digital assistant shown in the diagram has a panel module 30, a subprocessor (SMPU) 31, a host processor (HMPU) 32 and other peripheral devices (PRPHL) 33.

The panel module 30 has a touch panel (TP) 4, a display panel (LCD) 5, a touch panel controller (TPC) 2 and a display driver (LCDDRV) 3. Although no special restriction is intended, a one-chip semiconductor device (DRVIC) 1 has the touch panel controller 2 and the display driver 4 which are formed in e.g. one semiconductor chip according to CMOS integrated circuit manufacturing technique. Although this is not particularly shown in the diagram, the semiconductor device 1 may be arranged to include the subprocessor 31, and the touch panel controller 2 and the display driver 3 may be materialized as separate semiconductor devices respectively.

It is not particularly shown in the diagram that the display panel 5 has e.g. a transparent electrode and pixels of liquid crystal formed on a glass substrate according to the display scale. The display panel 5 has: drive electrodes formed to connect to select terminals of the pixels in units of display lines; and signal electrodes formed to connect to signal terminals of the pixels, and extending in directions in which they intersect with the drive electrodes.

The display driver 3 accepts inputs of image data from the host processor 32, and sequentially scan-drives pixels in units of display lines through scan electrodes in synchronization with a display timing; the pixels of the scan-driven display lines are supplied with gradation signals according to display data, in which the gradation signals are controlled to be provided to signal electrodes in parallel. Thus, one display frame unit of image data can be displayed on the display panel 5 in each display frame period.

Although no special restriction is intended, the touch panel 4 has an in-cell structure in which the touch panel is formed on a surface of the display panel 5 integrally therewith, an on-cell structure in which the touch panel is disposed on the display panel or the like. In the touch panel 4, the drive electrodes (Y-electrodes) TY1 to TYi, and the detection electrodes (X-electrodes) RX1_1 to RXm_n are arranged to intersect with each other with a dielectric interposed therebetween; each capacitance Cxy is disposed at an intersecting position, and is connected to the corresponding X- and Y-electrodes. The Y-electrodes TY1 to TYi are electrodes extending along Y direction and disposed at predetermined intervals. The X-electrodes RX1_1 to RXm_n are electrodes extending along X direction and disposed at predetermined intervals. Although no special restriction is intended, the touch panel 4 has a Y driver (YDRV) 20 which receives drive-control signals from the touch panel controller 2 and then, drives the Y-electrodes TY1 to TYi. In the case of the touch panel 4 small in size, the touch panel controller 2 may include the Y driver 20. The touch panel 4 is operated as a so-called mutual capacitance type touch panel.

The touch panel controller 2 periodically integrates signals arising on the X-electrodes RX1_1 to RXm_n through capacitance components such as the capacitances Cxy between the Y-electrodes driven by the Y driver 20 and the X-electrodes RX1_1 to RXm_n, and creates detection data according to the capacitance components. Although no special restriction is intended, the touch panel controller 2 has: an input switch part (RXSW) 11; a detection part (RXDTC) 12; an AD converter (ADC) 13 which converts an analog signal into a digital signal; a scan buffer (SCNRAM) 14 for temporarily storing digital data resulting from the conversion by the ADC 13; and a control part (CNTLGC) 10 having the control of the whole touch panel controller 2.

The subprocessor 31 controls the initial setting on the touch panel controller 2, and the operation thereof. Also, the subprocessor 31 calculates a touch position which a finger has been brought close to based on detection data taken by the touch panel controller 2, and performs the assessment about extraneous noise. Although no special restriction is intended, in the case of doing away with the subprocessor 31, its function may be materialized by the host processor 32 instead.

The host processor 32 may have the whole control of the personal digital assistant. For instance, if the host processor 32 produces display data, the display driver 3 receives the display data, and supplies the display panel 5 with display signals according to the display data in synchronization with a display timing. Further, the host processor 32 receives position coordinates calculated by the subprocessor 31, analyzes an input operation on the touch panel 4 from the relations between the position coordinates and the display contents at that time, and performs the control in response to the input.

Although no special restriction is intended, the personal digital assistant includes, as the peripheral circuits 33, a communication control unit, which is necessary for the personal digital assistant, an image-processing unit, an audio-processing unit, and an accelerator for other data processing.

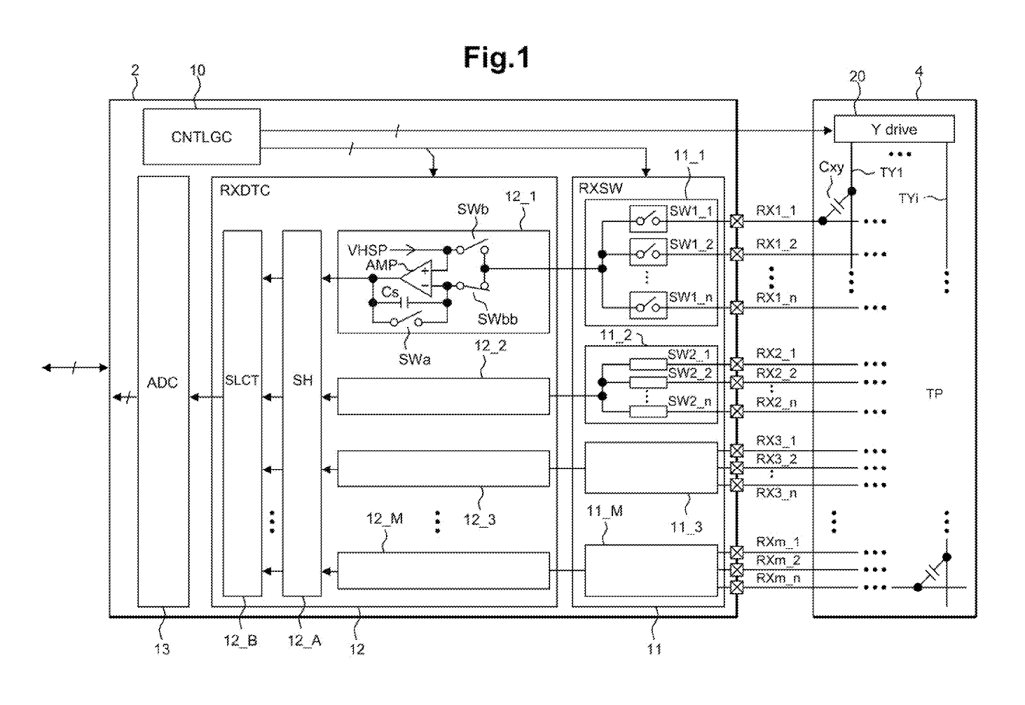

Referring to FIG. 1, the details of the input switch part 11 and the detection part 12 in the touch panel controller 2 are shown, by example.

Although no special restriction is intended, the X-electrodes RX1_1 to RXm_n are divided into m groups in units of n X-electrodes, and the input switch part 11 has m select units 11_1 to 11_{—}m which select the X-electrodes and output thereto in the respective groups. The select units 11_1 to 11_{—}m each have n switches SW capable of selectively connecting the respective n X-electrodes to corresponding output nodes. For instance, the select units 11_1 has switches SW1_1 to SW1_{—}n, and the select unit 11_2 has switches SW2_1 to SW2_{—}n. Likewise, the subsequent select units each have n switches.

The detection part 12 has integration circuit units 12_1 to 12_{—}m as detection circuits which are connected with outputs of the respective select units 11_1 to 11_{—}m. Outputs of the integration circuit units 12_1 to 12_{—}m are held by the sample-and-hold circuit 12_A; the signals thus held are sequentially selected by the selector 12_B, and supplied to the ADC 13. Signals resulting from the conversion by the ADC 13 are temporarily stored in the scan buffer 14 e.g. in units of detection frames, and then used for data processing by the subprocessor 31.

The integration circuit unit 12_1 includes e.g. a switch SWb for selectively applying, to the X-electrodes RX1_1 to RX1_{—}n, a precharge voltage VHSP for charging the X-electrodes RX1_1 to RX1_{—}n, an operational amplifier AMP arranged so that the voltage VHSP is applied to a non-inverting input terminal (+) as a reference voltage, a switch SWbb for selectively connecting the inverting input terminal (−) of the operational amplifier AMP to the corresponding X-electrodes RX1_1 to RX1_{—}n, and an integrating capacitor Cs and a switch SWa for resetting the integrating capacitor Cs which are disposed between the inverting input terminal (−) of the operational amplifier AMP and the output terminal. The switch SWa serves to reset an electric charge accumulated by the capacitor Cs used for detection. Although no special restriction is intended, the switch SWb is kept off during a pulse-drive period of the Y-electrodes TY1 to TYi; the switches SWb and SWbb are controlled in switching to be complementary to each other. The other integration circuit units 12_2 to 12_{—}m are arranged likewise, which are not particularly shown in the diagram.

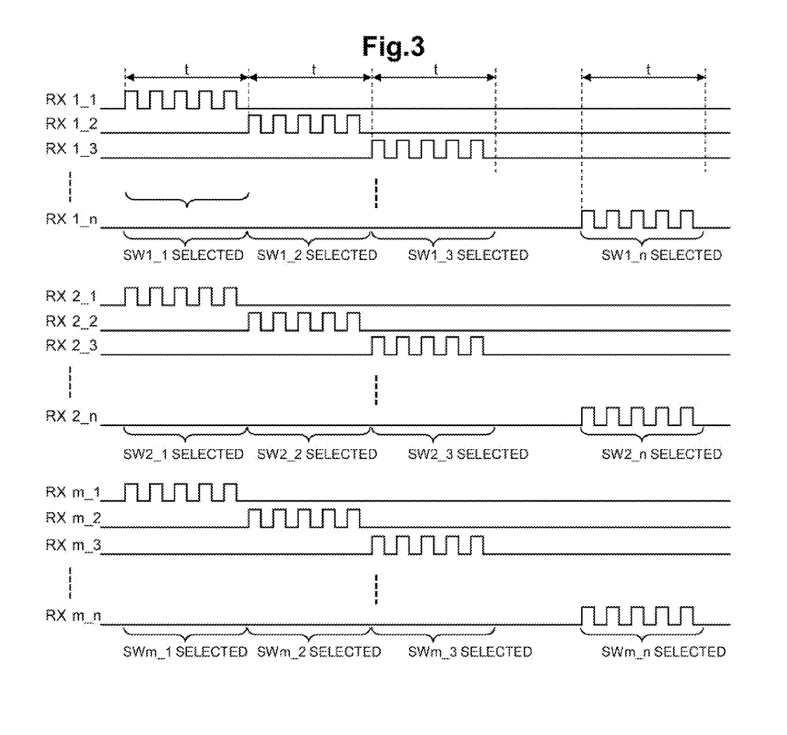

As clear from the above description, each of the integration circuit units 12_1 to 12_{—}m is shared for detecting signals arising on the n X-electrodes RXj_1 to RXj_n (1≦j≦m). In touch detection scan, the control part 10 sequentially selects the X-electrodes RXj_1, . . . , RXj_n in a time-division method by the switches SWj_1, . . . , SWj_n for each select units 11_1 to 11_{—}m, and the detection circuit 12_{—}j accepts the input of signals from the selected X-electrode and then, produces detection signals. FIG. 3 shows, by example, the states of the X-electrodes selected by the switches SW1_1 to SWM_n in the touch detection scan. In FIG. 3, each pulse staying at High level means that the X-electrode concerned is selected by the corresponding switch in a period during which the pulse stays at High level. In the embodiment of FIG. 3, it is repeated to select one X-electrode five times in succession, which is arranged to correspond to that the number of times that one Y-electrode is pulse-driven is made five. It is also possible to keep the X-electrodes selected by the switches throughout a period during which one Y-electrode is pulse-driven five times in succession. In other words, five successive pulses may be changed into a single long pulse. As is clear from FIG. 3, it requires a length of time equal to t times n to detect, by the integration circuit units 12_1 to 12_{—}m, signals arising on all the X-electrodes RX1_1 to RXm_n in response to pulse driving of one Y-electrode, where “t” is a length of time it takes to detect, by the integration circuit units, signals arising on all the X-electrodes RX1_1 to RXm_n in response to pulse driving of one Y-electrode in the case of assuming that one integration circuit unit is disposed only for each of the X-electrodes RX1_1 to RXm_n.

Now, an example of the integrating operation of the integration circuit units 12_1 to 12_{—}m in touch detection scan will be described. For instance, the Y-electrodes TY1 to TYi are sequentially pulse-driven in synchronization with a period of a touch detection frame. The number of drive pulses per Y-electrode is desirably more than one. In each integrating operation, the switch SWa is turned on first, whereby the electric charge of the capacitor Cs is reset. Then, in each of the select units 11_1 to 11_{—}m, the switches SWj_1 to SWj_n are turned on from the topside (the side of the SWj_1) sequentially in every period of the time t; each time the state where the corresponding X-electrode remains selected is created, the corresponding X-electrode selected by each of the select units 11_1 to 11_{—}m is precharged with the voltage VHSP by turning the switch SWb on and the switch SWbb off in a non-drive period of the Y-electrode. With the selected X-electrodes precharged, the Y-electrodes TY1 to TYi are sequentially pulse-driven more than once. In each of the pulse driving, the switch SWb is turned off, and the switch SWbb is turned on. In the switch condition like this, if the corresponding Y-electrode is pulse-driven (the pulse voltage is denoted by Vy), electric charge (=Vy×Cxy) is caused to transfer to the precharged X-electrodes through node capacitances Cxy on the Y-electrode, and the output voltage of the operational amplifier AMP receiving the electric charge at its inverting input terminal (−) is lowered by a voltage representing the electric charge thus transferred. If a finger is located near the node capacitances Cxy, stray capacitances produced thereby decrease the capacitance values of the node capacitances Cxy. Supposing that e.g. finger approach decreases a combined capacitance by a capacitance value Cf, an electric charge input to the operational amplifier AMP associated with the X-electrode concerned is Vy×(Cxy−Cf). Therefore, a decrease in the level of an output of the operational amplifier AMP with a touch being made is smaller than a decrease in the level of the output with no touch. A large volume of detection signals can be obtained by repeating the above operation each time the Y-electrode is pulse-driven, which is to be performed more than once successively.

The touch panel controller 2 performs a noise detection scan in addition to the touch detection scan. The noise detection scan is an operation in which signals from the X-electrodes RX1_1 to RXm_n collectively selected in the select units 11_1 to 11_{—}m are input to the corresponding integration circuit units 12_1 to 12_{—}m, and the integration circuit units produce detection signals. As is clear from the above description, the touch detection scan performs a switched capacitor operation and therefore, it is strongly affected by power source noise, the drive noise of the display panel caused by the display driver 3 and the like. The power source noise includes e.g. fluctuation of a terminal ground to the earth ground which largely depends on the operation frequency of a regulator included in an AC charger. The noise detection scan is for detecting a quantity of such noise.

The control of the touch detection scan and the control of the noise detection scan are performed according to a sequence control logic of the control part 10. For instance, both the touch detection scan and the noise detection scan may be executed in a period of a display frame rate. In addition, an arrangement may be made so that the touch detection scan is performed once or more than once in each period of the frame rate, and the noise detection scan is performed every two or more periods of the frame rate.

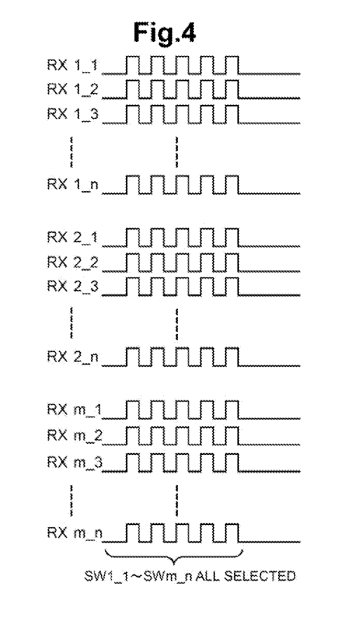

The noise detection scan is different from the touch detection scan in operation as described below. The first difference is that all the X-electrodes are selected in the select units 11_1 to 11_{—}m. FIG. 4 shows, by example, states of the X-electrodes selected by the switches SW1_1 to SWM_n in the noise detection scan. The second difference is that the Y-electrodes TY1 to TYi are not driven. According to the arrangement like this, the integrating operations will be performed while avoiding the inflow of electric charges from the Y-electrodes TY1 to TYi. Therefore, only pieces of information concerning the influence of extraneous noise will be accumulated in the integration circuit units 12_1 to 12_{—}m. Now, it is noted that the number of times that the X-electrodes are selected successively is not limited to five as in the embodiment shown in FIG. 4.

According to the above embodiment, the X-electrodes RX1_1 to RXm_n for detection are divided into groups in units of more than one X-electrode; and integration circuit units 12_1 to 12_{—}m each serving as a detection circuit are disposed for the groups respectively. The integration circuit units 12_1 to 12_{—}m are used to perform the noise detection scan. From these viewpoints, the downsizing of a semiconductor device 1 with a touch panel controller 2 provided on the chip can be materialized. Further, in the noise detection scan, the select units 11_1 to 11_{—}m select all the X-electrodes RX1_1 to RXm_n for detection, and a total quantity of noise is detected for each group. Therefore, unlike a method which enables the detection of noise in units of electrodes, a length of time required for noise detection can be shortened with the same scan method as in the touch detection scan. As is apparent from the comparison between FIGS. 3 and 4, a processing time required for noise detection scan is 1/n of the time required for touch detection scan. In the case of executing the touch detection scan and the noise detection scan in a period of a display frame rate, it becomes possible to readily perform a necessary noise detection scan within a limited length of time without limiting a touch detection scan operation time.

Further, all the Y-electrodes TY1 to TYi are stopped from being driven in the noise detection scan and as such, only noise components can be accumulated and detected by the integration circuit units 12_1 to 12_{—}m. Therefore, in analyzing the magnitude of extraneous noise, it is not required to consider whether the touch panel is being touched or not, so it becomes easier to make a determination about extraneous noise, which contributes to the enhancement of the accuracy of the determination.

Since the downsizing of a semiconductor device 1 having an on-chip touch panel controller 2 can be materialized, the downsizing of a frame like a picture frame for a peripheral portion of a display screen can be realized in regard to a panel module 30 including a semiconductor device 1, a touch panel 4 and a liquid crystal display panel 5, and having a function of touch detection and a display function incorporated therein.

The invention is not limited to the above embodiments. It is obvious that various changes and modifications may be made without departing from the subject matter thereof.

As to the above embodiments, cases in which touch detection is performed according to the mutual capacitance method are taken for example. However, the invention is not limited to the embodiments. The invention can be applied to a case in which touch detection is performed according to the self capacitance method. For instance, in the case of performing touch detection according to the self capacitance method, detection circuits should be disposed for both of X- and Y-electrodes. In such case, the effect of reducing the number of detection circuits can be achieved on both the sides of the X- and Y-electrodes where the detection circuits are disposed.

A circuit module to the semiconductor device provided on the chip thereof is not limited to the above embodiments, which may be changed appropriately. In the minimum scale, it is sufficient to provide only the touch panel controller on the chip. The semiconductor device can be provided on the chip of a display driver, a subprocessor, a host processor or another circuit module on an as-needed basis.

Further, it may be arranged in a system-on-a-chip form.

The display panel is not limited to a panel having liquid crystal display elements formed therein. It may be another display cell or a panel of display type, such as a plasma display panel or an electroluminescence panel.

The electronic apparatus is not limited to a panel module or a personal digital assistant. It may be a touch input and display system in a car navigation device.

Also, the arrangement of the integration circuit units 12_1 to 12_{—}m is not limited to the above embodiments. It can be appropriately changed to e.g. another circuit form which works as a switched capacitor. The number of switches SW1_1 to SWm_n may be decided appropriately.

What is claimed is:

1. A semiconductor device comprising:
a touch panel controller operable to periodically capture signals using receiver electrodes disposed in a touch panel to generate detection data indicating a touch or no touch, wherein the receiver electrodes are part of touch panel electrodes that extend in X and Y directions, wherein the touch panel electrodes are arrayed at predetermined intervals in the X and Y directions,
wherein the touch panel controller comprises detection circuits, wherein the receiver electrodes are divided into groups of at least two of the receiver electrodes, and wherein each of the detection circuits corresponds to a respective one of the groups, and
wherein the touch panel controller is operable to perform a touch detection scan and a noise detection scan, wherein, during the touch detection scan, each detection circuit accepts input of signals from the receiver electrodes sequentially selected in a time-division manner to produce detection data for the corresponding group, and wherein, during the noise detection scan, each detection circuit accepts input of signals from the receiver electrodes simultaneously in the corresponding group to produce detection data.

2. The semiconductor device according to claim 1, further comprising switches between inputs of the detection circuits and the receiver electrodes in the corresponding groups,
wherein the receiver electrodes in each of the respective groups are selected by the switches in the time-division manner during the touch detection scan, and
wherein all the receiver electrodes in each of the groups are selected by the switches during the noise detection scan.

3. The semiconductor device according to claim 2, further comprising a control part operable to control execution of the touch detection scan and the noise detection scan in a display frame rate period.

4. The semiconductor device according to claim 1, wherein the touch panel electrodes comprises X-electrodes extending in the X direction which are arrayed at predetermined intervals in the Y direction, and Y-electrodes extend in the Y direction which are arrayed at predetermined intervals in the X direction,
wherein the groups each comprises at least two of the X-electrodes,
wherein, during the touch detection scan, each detection circuit captures signals according to capacitance components formed between each Y-electrode driven during the time when the Y-electrodes are sequentially driven, and the X-electrodes selected in units of the groups in the time-division manner, and produces detection data for each intersection of the X- and Y-electrodes,
wherein, during the noise detection scan, the detection circuits capture signals according to capacitance components formed between the X-electrodes all selected in each corresponding group and the Y-electrodes and create detection data for each X-electrode, wherein the Y-electrodes are not driven sequentially during the noise detection scan.

5. The semiconductor device according to claim 4, wherein the Y-electrodes are not driven in the noise detection scan.

6. The semiconductor device according to claim 1, further comprising a processor which determines a touch or no touch based on detection data detected in the touch detection scan, and determines a noise level based on detection data detected in the noise detection scan.

7. The semiconductor device according to claim 1, further comprising a display driver configured to control a liquid crystal display panel disposed under the touch panel.

8. An electronic apparatus comprising:
a touch panel;
a touch panel controller operable to periodically capture signals using receiver electrodes in the touch panel to generate detection data indicating a touch or no touch, wherein the receiver electrodes are part of touch panel electrodes that extend in X and Y directions, wherein the touch panel electrodes are arrayed at predetermined intervals in the X and Y directions,
wherein the touch panel controller comprises detection circuits, wherein the receiver electrodes are divided into groups of at least two of the receiver electrodes, and wherein each of the detection circuits corresponds to a respective one of the groups, and
wherein the touch panel controller is operable to perform a touch detection scan and a noise detection scan, wherein, during the touch detection scan, each detection circuit accepts input of signals from the receiver electrodes sequentially selected in a time-division manner to produce detection data for the respective group, and wherein, during the noise detection scan, each detection circuit accepts input of signals from the receiver electrodes simultaneously in the corresponding group to produce detection data;
a liquid crystal display panel; and
a display driver configured to control the liquid crystal display panel disposed under the touch panel.

9. The electronic apparatus of claim 8, further comprising:
a semiconductor device comprising the touch panel controller and the display driver, the semiconductor device is configured to perform display control of the liquid crystal display panel and control touch detection performed by the touch panel.

10. A semiconductor device comprising:
a touch panel controller operable to periodically capture signals using receiver electrodes disposed in a touch panel to generate detection data indicating a touch or no touch,
wherein the touch panel controller comprises detection circuits, wherein the receiver electrodes are divided into groups of at least two of the receiver electrodes, and wherein each of the detection circuits corresponds to a respective one of the groups, and
wherein the touch panel controller is operable to perform a touch detection scan and a noise detection scan, wherein, during the touch detection scan, each detection circuit accepts input of signals from sequentially selected receiver electrodes in the corresponding group in order to produce detection data for the corresponding group, and wherein, during the noise detection scan, each detection circuit accepts input of signals from the receiver electrodes simultaneously in the corresponding group to produce detection data.

11. The semiconductor device of claim 10, wherein the receiver electrodes are part of touch panel electrodes that extend in X and Y directions, wherein the touch panel electrodes are arrayed at predetermined intervals in the X and Y directions.

12. The semiconductor device of claim 10, further comprising switches between inputs of the detection circuits and the receiver electrodes in the corresponding groups,
wherein the receiver electrodes in each of the respective groups are selected by the switches in a time-division manner during the touch detection scan, and
wherein all the receiver electrodes in each of the groups are selected by the switches during the noise detection scan.

13. The semiconductor device of claim 12, further comprising a control part operable to control execution of the touch detection scan and the noise detection scan in a display frame rate period.

14. The semiconductor device of claim 10, wherein the receiver electrodes are arranged on the touch panel such that each of the receiver electrodes extend in a common direction in the touch panel.

15. The semiconductor device of claim 10, wherein, during the noise detection scan, the detection circuits capture signals according to capacitance components formed between the receiver electrodes in the corresponding group which are all selected and transmitting electrodes that intersect the receiver electrodes in the touch panel, wherein the transmitter electrodes are not driven sequentially during the noise detection scan.

16. The semiconductor device of claim 15, wherein the transmitter electrodes are not driven during the noise detection scan.

17. The semiconductor device of claim 10, further comprising a processor which determines a touch or no touch based on detection data detected in the touch detection scan, and determines a noise level based on detection data detected in the noise detection scan.

18. The semiconductor device of claim 10, further comprising a display driver configured to control a liquid crystal display panel disposed under the touch panel.

19. The semiconductor device of claim 10, wherein, during the touch detection scan, each detection circuit captures signals according to capacitance formed between each receiver electrode in the corresponding group and transmitter electrodes which are sequentially driven to produce detection data for each intersection of the receiver and transmitter electrodes.

20. The semiconductor device of claim 19, wherein the receiver electrodes extend in a first direction in the touch panel and the transmitter electrodes extend in a second direction in the touch panel, wherein the first direction is perpendicular to the second direction.
